(19) United States
(12) Patent Application Publication
(10) Pub. No.: US 2026/0336733 A1
(43) Pub. Date: Oct. 29, 2026

(54) STORAGE, SORTING, AND RETRIEVAL OF BICYCLES, MICRO-TRANSPORT DEVICES AND PACKAGES

(71) Applicant: LINEAR VENTURES LLC, Greenwich, CT (US)

(72) Inventor: Andrew Hayes, Greenwich, CT (US)

(21) Appl. No.: 19/111,546

(22) PCT Filed: Sep. 13, 2023
(86) PCT No.: PCT/US2023/032639

§ 371 Date: Mar. 13, 2025

Related U.S. Application Data
(60) Provisional application No. 63/406,200, filed on Sep. 13, 2022.

(51) Int. Cl. B62H 3/00; A62C 3/00; B65D 85/68; B65G 1/06

(52) U.S. Cl. CPC B62H 3/00; A62C 3/002; B65D 85/68; B65G 1/06; B65G 2201/0235

(57) ABSTRACT

A portable storage container for a personal transportation device, including two or more housing portions; and two or more personal transportation device mounting portions coupled to at least one of the housing portions and each configured to receive a personal transportation device.

### CROSS-REFERENCE TO RELATED APPLICATION

The present application claims priority to U.S. Provisional Application Ser. No. 63/406,200, filed on Sep. 13, 2022, the contents of which is hereby incorporated by reference in its entirety.

### TECHNICAL FIELD

This disclosure generally relates to an automated storage system for personal transportation devices, such as bicycles, as well as other items provided to consumers or other persons in public spaces.

### BACKGROUND

The modern mobility revolution seeks to replace the car-focused urban streets of the 20th century with city-wide networks of lanes for two-and three-wheeled cycles and carts, powered by human pedaling, electric motors, or both. Building a genuine, broadly-based biking culture calls for more than just building bike lanes, however. It calls for new infrastructure that is able to safely store, charge, and quickly retrieve sufficiently large numbers of bikes (and e-bikes, scooters, and the like), at both trip origin and destination points, giving riders easy access to a reliable supply of bikes and storage spaces.

Separate from biking infrastructure, the rapid growth of online shopping has led to a significant increase in the usage of urban delivery vans and carts, to bring purchases to the customers' doorstep or lobby. Besides increasing urban vehicular traffic, these “last-mile” or “micro-distribution” delivery vehicles create further problems when drivers unload large numbers of packages in parking spaces, traffic lanes, or other public spaces to sort and organize them for final delivery.

### SUMMARY

This disclosure describes technologies relating to storage, sorting, and retrieval systems for personal transportation devices (such as bicycles, e-bikes, and scooters), packages, and other items.

Implementations of the present disclosure include a portable storage container for a personal transportation device, including two or more housing portions; and two or more personal transportation device mounting portions coupled to at least one of the housing portions and each configured to receive a personal transportation device.

In some implementations, the two or more housing portions include a left housing portion and a right housing portion.

In some implementations, the two or more housing portions include a left housing portion and a right housing portion, and the left housing portion and right housing portion are configured to couple with one another to form a clam-shell enclosure.

In some implementations, the two or more housing portions are configured to couple with one another to form a fireproof enclosure.

In some implementations, the portable storage container is configured to hold a personal transportation device on each of at least two of the two or more housing portions.

In some implementations, the storage container further includes two or more guides configured to guide at least two personal transportation devices into a complementary relationship with one another in the container.

In some implementations, the storage container further includes a mid-panel, wherein at least one of the one or more personal transportation device mounting portions is coupled to the mid-panel.

In some implementations, at least one of the personal transportation devices includes a bicycle.

In some implementations, at least one of the personal transportation devices includes an e-bike.

In some implementations, at least one of the personal transportation devices includes a cargo bike.

In some implementations, the storage container further includes a charging port for a chargeable electrical device of the personal transportation device.

In some implementations, the storage container further includes a fire detection device.

In some implementations, the storage container further includes a fire suppression device.

Further implementations of the present disclosure include a portable storage container for personal transportation devices. The portable storage container includes one or more housing portions, two or more personal transportation device mounting portions coupled to at least one of the housing portions and each configured to receive a personal transportation device, and one or more guides. The one or more guides are configured to guide at least one personal transportation device mounted in container into a complementary relationship with at least one other personal transportation device in the container.

In some implementations, at least one of the guides includes a receiving portion configured to receive a portion of the personal transportation device.

In some implementations, at least one of the guides includes user directions.

In some implementations, the two or more housing portions include a pair of opposing housing portions.

In some implementations, at least one of the mounting portions include one or more guides configured to guide a personal transportation device coupled to one of the housing portions into a complementary arrangement with at least one personal transportation device mounted to the opposing housing portion.

In some implementations, the portable storage container include a center partition. A mounting portion of the center partition comprises one or more guides configured to guide a personal transportation device coupled to the middle partition into a complementary arrangement with at least one personal transportation device mounted in an opposing housing portion.

Further implementations of the present disclosure include a storage system for personal transportation devices that includes two or more personal transportation device mounting portions and one or more guides. The two or more personal transportation device mounting portions are each configured to receive a personal transportation device. The one or more guides are configured to guide at least one personal transportation device into a complementary arrangement with at least one other personal transportation device.

In some implementations, the storage system includes one or more housing portions configured to enclose the personal storage devices.

In some implementations, the storage system includes one or more pallets.

In some implementations, the storage system includes two or more bars, wherein each of at least one of the mounting portions is coupled to one or more of the bars.

In some implementations, at least two adjacent personal transportation devices are in an alternating relationship to one another.

In some implementations, at least two adjacent personal transportation devices are in an inverted relationship to one another.

In some implementations, at least two adjacent personal transportation devices are in a syndiotactic relationship to one another.

Further implementations of the present disclosure include a method of storing personal transportation devices in a container that includes: placing a first personal transportation device in a first location in the container; and placing a second personal transportation device in a second location in the container such that the second personal transportation device is in a complementary relationship to the first personal transportation device.

In some implementations, the method includes mounting the first transportation device on a first side of the container, and mounting the second transportation device on a second side of the container opposite the first side, and arranging the first side of the container and the second side of the container to form an enclosure for the first and second personal transportation devices.

In some implementations, placing the second personal transportation device include positioning the second transportation device such that the personal transportation devices are arranged in an alternating manner.

In some implementations, placing the second personal transportation device include positioning the second transportation device such that the personal transportation devices are arranged in a syndiotactic manner.

In some implementations, placing the second personal transportation device include positioning the second transportation device such that at least two adjacent personal transportation devices point in opposite directions from one another.

In some implementations, placing the second personal transportation device include positioning the second transportation device such that the second personal transportation device is inverted relative to the first personal transportation device.

Implementations of the present disclosure including a storage system for personal transportation devices and other items, including: an enclosure, one or more item release stations, and an item retrieval system. The enclosure is mounted on or adjacent to a paved surface. The enclosure defines a storage space including a plurality of storage positions. Each of at least one of the storage positions is configured to receive and store one or more personal transportation devices or one or more other items. The item retrieval system includes a plurality of motors configured to move items within the storage space and a controller. The controller is configured to operate at least two of the motors to retrieve items from a selected storage position and move personal transportation devices or other items from the selected storage position to at least one of the item release stations.

In some implementations, the storage space includes an array of storage positions arranged in two or more rows and two or more columns.

In some implementations, the storage space includes one or more aisles.

In some implementations, the storage includes two or more levels, wherein at least one of the motors is operable to move at least one of the items from one level to another.

In some implementations, the controller is configured to operate at least two of the motors to move items from different storage positions at the same time.

In some implementations, the motors are operable to move items in at least two different directions.

In some implementations, the motors are operable to move items linearly in a first direction and linearly in a second direction.

In some implementations, the two or more motors include a first set of one or more motors configured to move items in a first direction in the storage space, and a second set of one or more motors configured to move items in a second direction in the storage space.

In some implementations, the controller is configured to operate two or more motors moving synchronously.

In some implementations, the retrieval system is operable to move items from two or more positions by operating a single one of the motors.

In some implementations, the retrieval system is operable to move items to the storage positions for storage.

In some implementations, a first set of motor are part of a primary movement system, and a second set of motors are part of a secondary movement system.

In some implementations, the storage space includes an aisle adjoining at least one of the item release stations. At least a first one of the motors of the retrieval system is operable to move an item from a selected position to the aisle. At least a second one of the motors is operable to move the item from a location in the aisle to at least one of the item release stations.

In some implementations, at least one of the personal storage vehicles in at least one of the storage positions are in a container, and at least one of the motors is configured to move the personal transportation devices while the personal transportation devices are in the container.

In some implementations, at least one of the containers holds two or more personal transportation devices.

In some implementations, the two or more personal transportation devices are arranged in a complementary arrangement in the container.

In some implementations, the retrieval system includes one or more bars configured to couple with at least one of the personal transportation devices such that at least one of the motors can move the personal transportation device within the storage space.

In some implementations, other items stored in the storage positions are housed in containers.

In some implementations, at least one of the motors is above the storage positions.

In some implementations, at least one of the motors is below the storage positions.

In some implementations, the retrieval system includes a security device configured to separately control access to each of the items moved to item release station.

In some implementations, the security device include a locking device configured to inhibit removal of at least one retrieved personal transportation device.

In some implementations, the storage system further includes an electrical charging system for charging electrical device of the personal transportation devices.

In some implementations, the storage system further includes a fire detection system.

In some implementations, the storage system further includes a fire suppression system.

In some implementations, the paved surface includes a sidewalk.

In some implementations, the paved surface is adjacent to a street for motorized vehicles.

In some implementations, the enclosure is spaced from a fire hydrant by a predetermined minimum distance.

In some implementations, the storage space at least partially surrounds a fire hydrant.

In some implementations, the storage system defines a space to accommodate a fire hydrant.

In some implementations, the storage system includes a fire hydrant extender coupled to a fire hydrant, wherein the fire hydrant extender is configured to couple with fire-fighting equipment outside of the enclosure and to pass water from the hydrant to the fire-fighting equipment.

In some implementations, the storage system includes a fire hydrant test system.

Further implementations of the present disclosure includes a method that includes: operating two or more motors to store a personal transportation device in a storage position storage position in a storage system; and operating two or more motors to retrieve the personal transportation device from the storage position in a storage system.

In some implementations, operating the two or more motors to retrieve the personal transportation device from the storage position include operating a motor to move at least one other item from at least a second storage position in the storage system.

In some implementations, the methods includes operating at least a first motor to move items in at least one of the storage positions out of the way of a selected item, and operating at least a second motor to move the selected item at least part of the way to at least one item release station.

In some implementations, at least two of the motors used to retrieve the personal transportation device are operated simultaneously.

Particular embodiments of the subject matter described in this disclosure can be implemented so as to realize one or more of the following advantages.

The concepts described within this disclosure can be used to provide more storage for personal transportation vehicles, in a more compact manner.

The concepts described within this disclosure can be used to provide more storage for personal transportation vehicles, in a more compact manner. The concepts described within this disclosure can be used to provide faster storage and retrieval of personal transportation devices. The concepts described within this disclosure can allow for reliable infrastructure to re-charge batteries (or to allow private riders to swap batteries) for e-bikes. The concepts described within this disclosure can allow for increased utilization of cargo bikes. The concepts described within this disclosure can allow for reliable infrastructure to re-charge batteries (or to allow private riders to swap batteries) for e-bikes. The concepts described within this disclosure can make use of dead space in public areas, such as around fire hydrants. The concepts described within this disclosure can provide for reduced congestion and faster delivery of packages and other items in congested areas.

The details of one or more implementations of the subject matter described in this disclosure are set forth in the accompanying drawings and the description below. Other features, aspects, and advantages of the subject matter will become apparent from the description, the drawings, and the claims.

### BRIEF DESCRIPTION OF THE DRAWINGS

FIG. 1A is a block diagram plan view of a storage system for personal transportation devices and other items.

FIG. 1B is a block diagram elevation view of a storage system for personal transportation devices and other items.

FIG. 2 illustrates a container for storing two bicycles in a complementary arrangement.

FIG. 3 is a cross sectional view of the container illustrated in FIG. 2.

FIGS. 4A and 4B illustrate use of a container to store and access either of two bicycles.

FIGS. 5A and 5B illustrate a container for storing bicycles in a complementary arrangement with a center partition.

FIG. 6 illustrates a bicycle storage container that allows for inverted storage of one bicycle relative to another bicycle.

FIG. 7 illustrates a system for storing and retrieving bicycles and other items according to some implementations.

FIG. 8 illustrates a system for storing and retrieving bicycles and packages according to some implementations.

FIG. 9 illustrates a system for storing personal transportation devices near a public fire hydrant.

FIG. 10 illustrates a system for storing personal transportation devices that includes a fire hydrant extension system.

FIG. 11 illustrates an alternate implementation that includes motor assemblies that move items left-to-right and front-to-back.

Like reference numbers and designations in the various drawings indicate like elements.

### DETAILED DESCRIPTION

Systems and methods of storing, sorting, and retrieving items, including smart, energy-efficient systems that can reduce congestion and carbon emissions, are described herein. In one example, using synchronized, energy-efficient motors in a secure, automated enclosure, a storage system quickly stores, sorts, and retrieves up to 36 bikes/e-bikes (and even more scooters). The system can also store, sort, and retrieve over 1,000 cubic feet of packages (on standard-sized pallets, or in bags or bins of packages). The system can also offer a range of other amenities such as benches, green walls, elevated café seating, EV and e-bike chargers and battery swapping. In one implementation, the system includes in a box 4 feet high and 9 feet deep, installed in 33 feet of curbside space (e.g., two parking spaces, adjacent to the sidewalk).

The system can be sufficiently flexible and scalable that it can also be utilized in a variety of other locations and other types of installations. For example, in small cities and suburbs, e.g., dozens of bikes can be stored in just a couple of parking spaces next to a commuter train or bus platform. In some implementations, local shopping areas offer secure bike storage (and charging) to customers.

For illustrative purposes, payloads of containers and storage systems described herein often shown or described as “bicycles” or “bikes”. However, depending on the system, the actual payload can include other personal transportation devices and other items. Some examples of personal transportation devices that can be stored and retrieved include purely pedal-powered bicycles, bicycles with electrical motors, cargo bikes, professional delivery bikes, e-bikes, scooters, and electric-powered scooters and tricycles, or any combination thereof. Payloads can also include accessories and related equipment such as helmets, gloves, other cycling equipment, and batteries for e-bikes.

As used herein, a “storage system” includes a system that stores, retrieves, and/or sorts personal transportation devices, packages, or other items. A storage system can also perform other functions, such as charging, fire suppression, fire detection, vending, shelter, or entertainment.

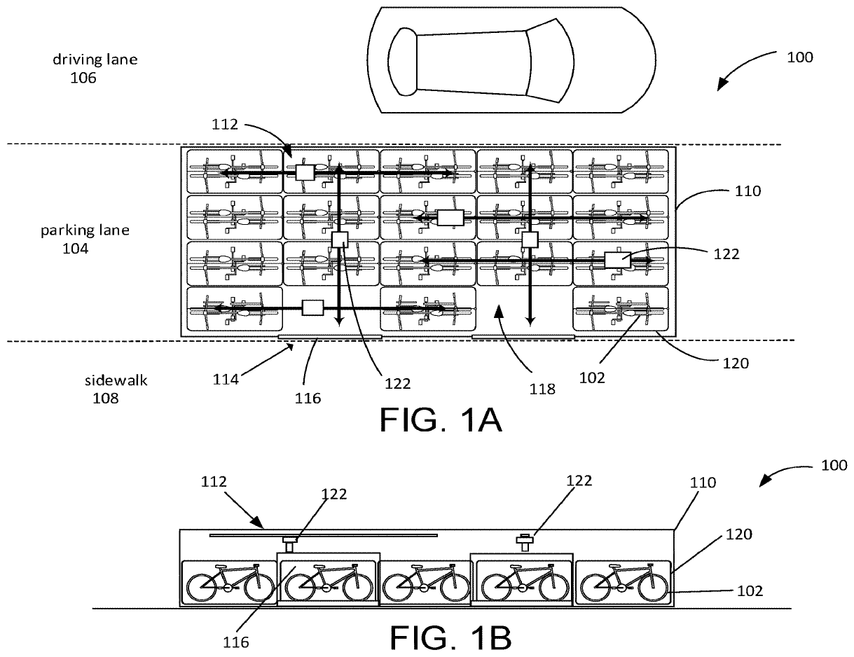

FIGS. 1A and 1B are block diagrams of a storage system for personal transportation devices and other items. Storage system 100 provides for storage of bicycles 102 on a public street. In this example, storage system 100 is located in curbside parking lane 104. Curbside parking lane 104 is located between driving lane 106 and sidewalk 108. Storage system 100 adjoins driving lane 106 on the street side and adjoins sidewalk 108 on the pedestrian side.

Storage system 100 includes enclosure 110, bicycle retrieval system 112, and bicycle retrieval stations 114. Bicycle retrieval stations 114 include access doors 116.

Enclosure 110 defines a storage space 118 in which bicycles 102 are stored in containers 120. Bicycle retrieval system 112 includes tracks 121 and motors 122.

Motors 122 are operable to move bicycles between storage positions in storage space 118 and bicycle retrieval stations 114.

### Containers for Personal Transportation Devices

The following describes implementations of containers that can be in storage systems described herein.

### (1) Fire-Safe Enclosed Storage Device for One or More Bikes

In some implementations, a sealable container (such as a suitcase-type or “clamshell”-type of container) encloses one or two bicycles (powered by pedals, batteries, or a combination), scooters, or a combination of bikes, scooters, and similarly-sized wheeled transportation devices. The wheels of the devices can remain attached, and with any battery installed, such that the bike or other vehicles can be immediately used once removed from the container.

The material of the container can be such that it protects the vehicles inside from fire, and/or works with a fire suppression system. Alternative implementations can accommodate methods in which one or both wheels are removed, or other equipment is adjusted so that the storage space used by the bike is minimized.

In some implementations, a fire-safe clamshell container includes some or all of the following features:
a. Storing of one or more wheeled vehicles in a space-efficient manner, as part of a system of multiple storage containers, and in a way that still permits the personal transportation vehicles to be used immediately upon removal from the container (as described below), while cushioning the stored vehicles from damage;
b. a wired or other connection facilitating the charging of vehicles stored inside the container;
c. a substantial fire barrier, preventing any fire inside the container from spreading outside, and to protect its contents from any fire outside the container;
d. fire detection, via a heat sensor inside the container; and
e. operation in combination with an active fire suppression system outside the container, such as an emergency nozzle that allows firefighters to inject fire-suppressing foam or other materials into the container.

### (2) “Offset” Storage Device for Two or More Bikes

In various implementations, personal transportation devices are arranged in a manner that a bike is oriented or positioned in a manner that is complementary to one or more other bicycles.

In one implementation, a single device supports, and enables compact storage of, two or more bikes or other small wheeled vehicles, with the handlebars (or guidebar, as the case may be) of each vehicle facing in different directions (e.g., “offset” from each other). The pedals (if any) of each vehicle aligned so that they are also “offset” from each other.

An “offset” configuration can significantly reduce the width of the storage space compared to storing the bikes with handlebars adjacent to each other, while still providing a cushion for the bikes from any external forces on the container.

The positioning of each bike to achieve this offset (or other complementary relationship) can be achieved in various ways inside the container itself. Examples include by drawings, signs, and written instructions and indentations in the insulating materials that suggest the placement of the bike, and/or by the location of the mechanisms used to secure each bike to the interiors of the container. As one example, one or more bars, latches, clamps, or cords on one side of the clamshell can be affixed to direct the customer to store their bike facing a particular direction. As another example, either a curved indentation in the device, or an indentation in the foam insulation of the device or both, direct the user to store their bike in such a way that its pedals aligned in a particular way (e.g., horizontally, though the alignment could also be northeast to southwest).

On the inside of the opposite side of the storage device, the bar, latches, clamp, or cords can be affixed on the opposite side of the interior, directing the customer to store their bike facing in the opposite direction from the customer described above, and either a curved indentation in the device, or an indentation in the foam insulation of the device, direct the user to store their bike in such a way that its pedals are aligned in a way that is the oppose of the bike described above (e.g., vertically, though the alignment could also be northwest to southeast).

Where the devices being stored in such a container are not bicycles as such, but scooters or powered skateboards whose design does not call for offsetting of pedals, the container can instead direct the user to secure their device in such a way that any handle bars or other vertical parts of the device are affixed to the side of the device (by a similar arrangement of hooks, latches, clasps, or fasteners) in a way that minimizes the total width of the devices stored inside the container.

Alternately, the area between the two bikes (or scooters) inside the storage container is made of a pliable foam or other soft material, able to adapt itself to the horizontal protrusion of each of the bikes' pedals, and any other protrusions, while still providing a barrier between the two.

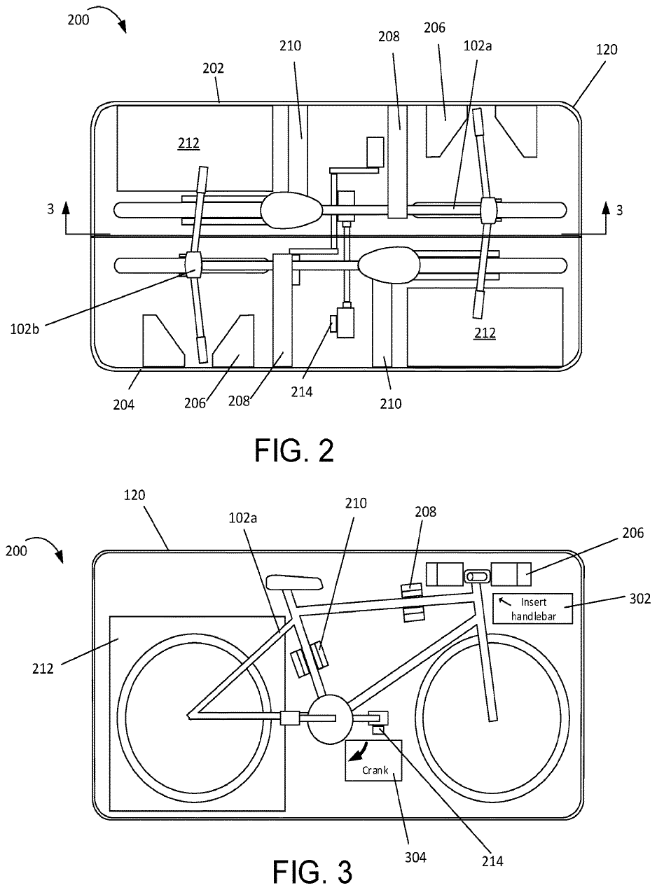

FIG. 2 illustrates a container for storing two bicycles in a complementary arrangement. FIG. 3 is a cross sectional view of the container illustrated in FIG. 2. System 200 includes container 120, which houses bicycles 102a, 102b. Container 120 includes left housing portion 202 and right housing portion 204. In this example, each of the housing portions are in the form of a clamshell. Mounting portions 206, 208, 210, and 212 are provided on each of housing portions 202 and 204.

Any or all of the mounting portions 206, 208, 210, and 212 can serve as guides for positioning bicycles 102a, 102b in container in a complementary manner to another bicycle (or bicycles) in the container. In addition, stop 214 can be used to help the user ensure that the pedals of bicycle 102a are in a location that complements those of the other bicycle in the container. Signs 302, 304 also serve as guides to help the user position each bicycle in a complementary arrangement with the other bicycle in the container.

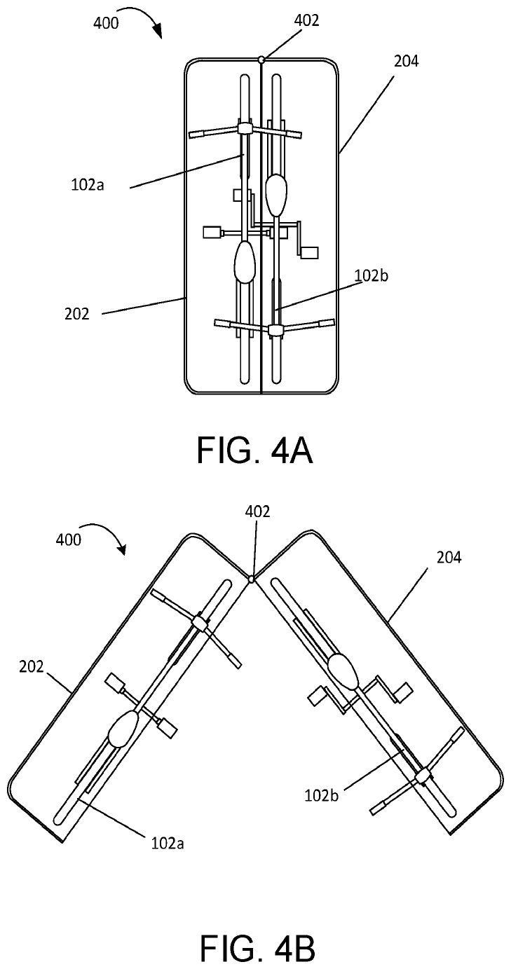

FIGS. 4A and 4B illustrate use of a container to store and access either of two bicycles. Container 400 includes left housing portion 202 and right housing portion 204. Left housing portion 202 and right housing portion 204 are connected by way of hinge 402. FIG. 4A shows container 400 in a closed position. Left housing portion 202 and right housing portion 204 combine to form protective enclosure for bicycles 102a, 102b.

FIG. 4B shows container 400 with left housing portion 202 and right housing portion 204 swung away from one another to provide access to bicycles 102a and 102b.

In some implementations, the area between the two bikes is a fire-resistant or proof fabric, which can be attached by a locking device, depending on which bike is being access by the user, or by a zipper, hook-and-loop, or other method that is accessible to the user.

(3) Tripartite and Quad Storage Containers. In another implementation, the container includes a stable, fixed central panel, separate from the two storage areas inside each of the container's two side panels, and formed in such a way that it is possible to affix a bike to one or both sides of this central panel.

The central panel can be made of the same material as the side panels, or of a separate material; it can be attached to a separate external area that attaches to each of the two external sides of the container, or to one or another of the edges of the sides of the container; but in either case it is made of material able to bear the weight of one or two bikes that are affixed to it, by means of the same attachment devices as are used on the inside of each side of the “clamshell” design.

This Tripartite or Quad container can provide for storing three or four bicycles (or up to six or eight scooters, or an equivalent combination of bikes and scooters) within a single container, depending on whether vehicles are stored by attaching them to one or both sides of the central panel (in addition to the vehicles stored by attaching them to the insides of each of the two respective outside portions of the container).

In the above examples, the storage containers can be connected via a wireless connection with a central monitoring or control system, as well as a video monitor affixed to the storage system itself, which is able to track and record who is accessing each container, and each part of each container, to minimize theft and vandalism.

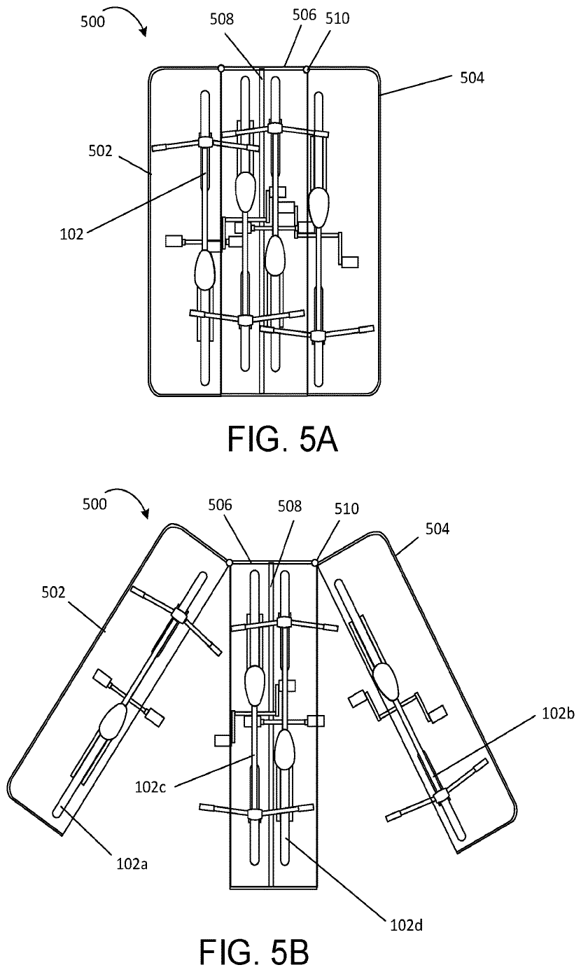

FIGS. 5A and 5B illustrate an example of a container including a central platform. Container 500 houses four bicycles 102. Container 500 includes left housing portion 502, right housing portion 504, and center housing portion 506. Center housing portion 506 includes center partition 508. Left housing portion 502 and right housing portion 504 are coupled to center housing portion 506 by way of hinges 510.

Bicycles 102a, 102b, 102c, and 102d are arranged in a complementary relationship in container 500. Bicycles 102a, 102b are each mounted to one of the exterior housing portions 502, 504. Bicycles 102c and 102d are coupled to central partition 508 in a complementary arrangement to one another and to the bicycle in the adjacent exterior housing portion.

(4) Open “Offset” Vehicle Storage System. What is claimed is a storage system for multiple bikes and other wheeled vehicles in the “offset” configuration described above (but not inside a sealable container), which is connected to a one or more other devices that are able to be moved around and within a defined storage space.

As with the Sealed Offset Storage containers described above, each of the Open Offset Storage devices can be attached to the storage system by a fixed connection that is above the device, or by a hook, chain or other flexible connection; or attached to the front or rear of the device by a fixed connection; or placed on top of a pallet or connection to the network of motors.

Vehicles are stored in these Open Offset Storage devices by attaching them to one or more horizontal bars or tubes, and/or vertical columns or tubes, by means of latches, straps, clips, or Velcro connections. These latches and connections can be controlled by a key or remote access system so that only one vehicle at a time is released, while other vehicles attached to the same bar or tube remain attached to the storage mechanism.

A computer system can be used to monitor the connections between the stored vehicles and the storage device itself.

Open Offset Storage devices can also have mechanisms to ensure that parts of the vehicles are affixed in the most space-efficient manner, such as positioning of the pedals, by use of signs, indentations in the device, or other means described in the preceding paragraphs. Open Offset Storage devices can also include extensions, folding appendages, or other devices intended to secure or stabilize portions of the stored vehicles, and to prevent unintended movement of parts of the stored vehicles.

Open Offset Storage devices can store more than two vehicles by use of more than one sets of bars, columns, or tubes, permitting the storage of three or more bikes, e-bikes, scooters, powered skateboards, or similar vehicles. In some implementations, the multiple bars, columns, or tubes can be connected by a hinge, accordion extension, or other device that expands the space occupied by the storage unit, so that persons storing their vehicles on the device are able to move the bars and columns apart from each other, making it easier to store or attach the vehicle to the device.

Open Offset Storage devices can also include charging connections for battery-powered or other electrically-charged vehicles.

Open Offset Storage devices can also include one or more fire detection and suppression devices, including temperature gauges and connections that facilitate the dispensation of water, foam, or other fire suppression materials onto stored vehicles that may be on fire.

(4) Syndiotactic Storage System. The disclosed invention is a system for storing bikes in such a way that the vehicles are not only “offset”, as that term is used above, but also so that each pair of adjacent vehicles are inverted, relative to each other: i.e., the handlebars and seat at the top of one vehicle are adjacent to the wheels and pedals of the adjacent vehicle.

This type of design can be used in “clamshell” storage containers, of two, three, or four bikes; it can also be used in Open Offset storage systems, without containers, and in devices that store two or more bikes in such Open Offset storage containers. Where more than two bikes are store in one storage device, they can be stored so that while two bikes are syndiotactic to each other, the second and third bikes can simply be offset to each other, or inverted (but not offset).

Syndiotactic storage is typically achieved by a design in which access to the storage device is by a door that opens downward (like the tailgate on a truck), allowing the user to lift their bike up just a few inches (or roll the bike onto the edge of the open door, resting on the ground, from one side or another of the sidewalk adjacent to the door).

Alternately, syndiotactic storage may be achieved with a door that swings or slides sideways (or upwards), by having a part of the storage device itself (either the side of the “clamshell”, or a part of the storage mechanism) extend outward and downward, so that the user is able to place their bike, wheels down, onto either a defined area inside the storage system, or otherwise.

One advantage of a syndiotactic arrangement for three or four bikes is the ability to maximize storage compactness. For example, four e-bikes can be stored in a space that is no deeper than 48″—the depth of a standard package pallet used by a logistics delivery company. A system of this size can ensure a storage system's ability to store either bikes or packages in the same space.

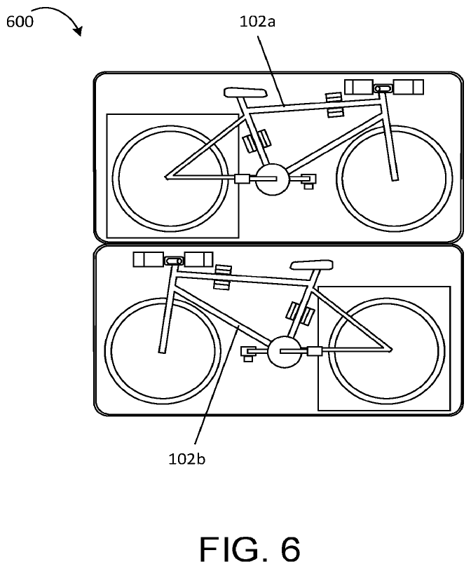

FIG. 6 illustrates a container 600 with two housing portions (e.g., clamshell) in which bicycles 102a, 102b can be stored in an inverted relationship to one another.

### Storage Systems for Personal Transportation Devices and Other Items

In some implementations, a system or machine includes a series of motors for horizontal and (optionally) vertical motion, installed in either the floor or ceiling of a secure, framed space, in a connected network of tracks, so that the motors are able to move and store bikes, containers of bikes, and/or packages (alone, or in piles or bags, bins or pallets) within a compact, three-dimensional space inside the device, and present them to users of the system.

The control system provides for synchronized movement of more than one motor at a time, moving its container, payload, or attached storage device at the same time as other motors are moving other containers, payloads, or attached storage devices around the system.

The motors' ability to move more than one container or storage device around and within the entire area of the enclosed space simultaneously reduces the need for ‘empty spaces’ within the enclosure, and maximizes the number of payloads that can be stored and retrieved in any specific amount of time-in a matter of seconds, not minutes.

The motors that move the containers or payloads horizontally and vertically can be suspended from a grid or network positioned above the containers or devices that are moving, or can be connected to the motors by hooks or a latch, or can be connected by a fixed bar and locking mechanism described below.

Alternately, the motors in this system that move the containers or payloads can be positioned in a track below their respective containers or storage devices, with the containers, payloads or storage devices above them.

Alternately, the motors in this system that move the containers or payloads can be attached to one end or side of their respective containers or storage devices, with the containers, payloads or storage attached to a bar or pallet that is attached at one end to a track that is moved by the motors (i.e., the motor is attached onto the front or back end of the bike holder or container).

Some implementations include a set of one or more types of linear motors (either linear synchronous motors, linear induction motors, or step motors). Implementations can, however, also include other types of motion devices, such as actuators or step motors.

In various implementations, devices can include a number of containers, payloads, or storage devices all at the same elevation, or can involve more than one horizontal “level” on which containers, payloads, or devices are stored. In multi-level storage systems, the vertical movement can be integrated into the motor system that provides movement of the containers, payloads, or storage devices, or it can be distinct from that system. Some implementations of storage systems with more than one level may have the ‘entry’ and ‘exit’ areas (i.e., “pickup” and “dropoff” areas) on a different elevation than the storage level itself (such as when the “pickup” and “dropoff”′ areas are on the ground floor, connected by an elevator to a storage area that is located in the basement).

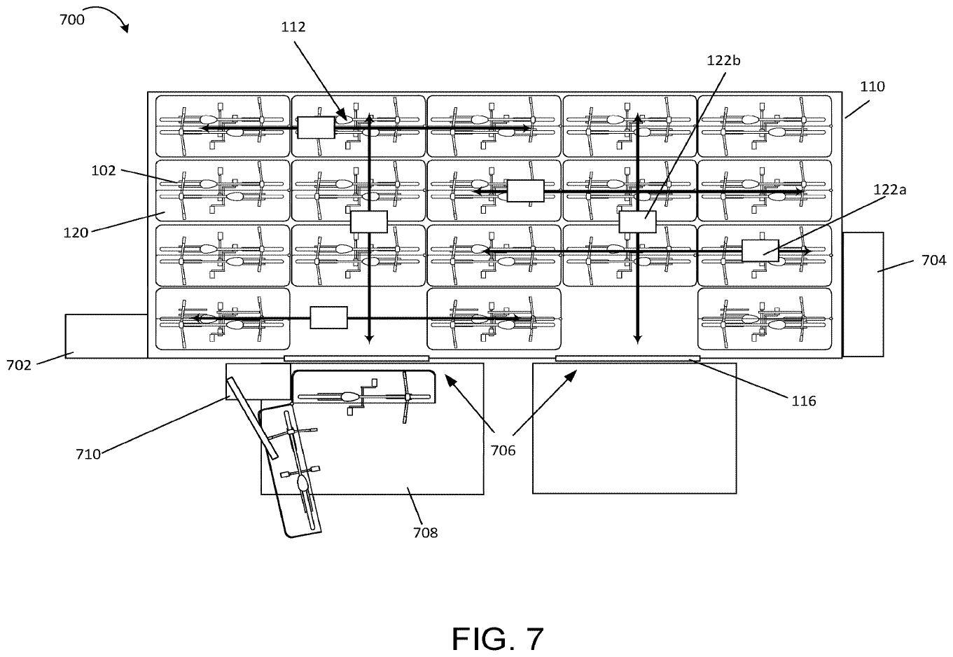

FIG. 7 illustrates a system for storing and retrieving bicycles and other items according to some implementations. System 700 includes an enclosure 110, charging station 702, fire suppression system 704, and item retrieval stations 706. Retrieval system 700 can be operated using a controller to bring items at one of the storage positions to one of item retrieval stations 706. Each of retrieval stations 706 includes a platform 708. Containers 102 can be opened at platforms 708. Item retrieval stations 706 can also include a container-opening device 710. In one implementation, container-opening device 708 includes a mechanism or arm that magnetically couples to a portion of container 120.

System 700 includes an array of storage positions arranged in rows and columns. Retrieval system 112 can be used to transport bicycle containers or other items to or from various storage positions. In various implementations, two or more motors are operated simultaneously. Retrieval system 112 can provide coordinated movement of containers or other items at two or more storage positions to facilitate bringing a particular item to or from a storage position. In some implementations, a side-to-side motor 122a brings an item from a storage position to an aisle, and then a front-back motor 122b brings the item to an item retrieval station 114.

In some implementations, motors are used to move items in adjacent storage positions at the same time. Thus, for example, all of the items in the last row can be moved toward the same end of the enclosure. Subsequently, one or more of the items that has been moved horizontally can be moved to an open storage position or to an item retrieval station. The controller can determine what combination of movements of the items achieves the fastest and/or most efficient retrieval or storage of a target item or items.

### Combined Storage Device Systems

Also disclosed are storage systems that combine two or more of the above-described automated storage devices and motor systems, within one space or storage area that is subject to a central controller.

Three devices that can be used to secure the bike(s) to the motor system include: (a) the “clamshell” device described in the preceding claim, in a variation that accommodates two bicycles; (b) a fixed bar, attached to either the bottom or the storage area or to its top, which c be defined by a metal frame, and (c) one or more adjustable attachments, such as hooks or latches, which may also be attached to the top of the storage area by a metal frame.

Each of these types of storage devices may be attached to the motor system in one of or more of the following ways: (i) affixed below a configuration of motors located above the bikes, with a secondary movement system that may move the bar or container vertically; (ii) attached at one end to a series of motors that move the bikes vertically or horizontally, or (iii) affixed on top of a configuration of motors that move the containers horizontally, with a secondary movement system that may move the bar or container vertically.

A single storage unit of storage may combine, e.g., e-bikes in fireproof clamshells that are either suspended from a ceiling, or sitting on motors underneath them, and also bikes or scooters that are not in a container, and are simply hanging from bars or columns attached to the top of the storage area, or to motors in the ceiling of the storage system.

A single storage area may also combine one or more of these storage systems for the types of wheeled vehicles described herein, with storage for “full-sized” automobiles (whether EVs, hybrids, or internal combustion engine vehicles), and/or other sized large vehicles (e.g., trucks, buses, or other group transit vehicles).

### Combined Bike and Package Storage Systems

The following are some examples of storage systems that can store either bikes or packages in a space-efficient manner.

### (1) Variable number of motors and pallets in Combined Storage System

In one instance of the proposed usage of the storage system for storing bikes and freight, the same sized pallet can be used for both types of payloads (putting aside the intrusion of the devices used to stabilize the bike, which may be addressed in any of the ways described below). However, most packages are much smaller than the size of a bicycle, and even when a number of packages are bundled together (in a bag, bin, or on a pallet), they still occupy a much smaller space: The standard freight pallet is 48″ by 40″. This is roughly half the size of a triple or quad storage device described above, which is about 48″ deep by no more than 80″ long. Thus, one way to have bike storage pallets double as freight storage pallets is to require that the freight company rent or use the entire size of the bike pallet.

Alternately, depending on the number of users and the size of their typical packages to be sorted and delivered, it may be preferable to have the bike storage “pallet” actually formed by two (or more) separate pallets. When the storage system is used for bike storage, these pallets are synchronized to move together, as if they were one “pallet” underneath the bike (e.g., two pallets, each 40″ by 48″, combine to form a storage space 48″ deep by 80″ long, fitting four bikes in the syndiotactic installation described above. When the bikes are removed from storage, then the movement of the two pallets in the device could be de-synchronized, so that each is able to store its own Amazon-sized wooden pallet of 48″×40″.

### (2) Removable Bike Storage Devices

In some implementations, the specific devices that provide for bikes storage (whether clamshells, or bars) are removable from the storage system, and are removed by a freight or other service operator in such a way that the entire space inside the storage system is then free to be used for package storage. Such an installation may be appropriate if a storage system is being re-purposed from bike storage to full-time package storage.

### (3) “Swing-Up Storage Bars”

In some implementations, the Open Offset bikes storage bars are affixed to motors and tracks in the ceiling of the storage device in such a way that they can be unlocked or un-latched, and rotated 90 degrees, so that they are flat against the ceiling of the storage area. This design then frees up the entire interior space. In one example, the bars, once folded up to the ceiling of the storage space, may be usable as hooks or hanging devices for bags of packages, so that they remain distinct from each other.

### (4) Swing Down Storage Bars

In some implementations, the Open Offset bikes storage bars are affixed to motors and tracks in the bottom of the storage device in such a way that they can be unlocked or un-latched, and rotated 90 degrees, so that they are lying flat against the floor of the storage area. This design then frees up the entire interior space. In one implementation, the bars, once laid flat, are of such a shape and location that they fit into the “sandwich” space between the bottom and top levels of the typical wooden freight pallet.

### (5) Infill Packages

In some implementations, the existing bike storage devices are not moved, but instead packages (either individual packages, or bags or bins of packages) are placed in the 24″ spaces between the fixed storage devices, and then moved around as if the payloads were bikes. This implementation may be useful where the storage system's main use is for bike storage, and the need for packages is very short-term, or limited.

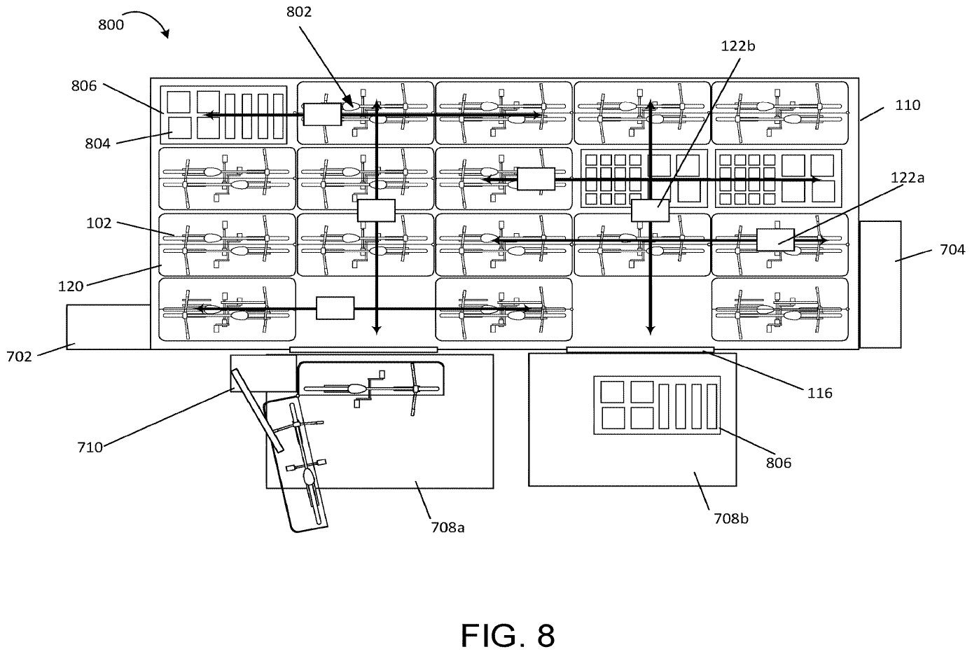

FIG. 8 illustrates a system that provides for storage and retrieval of bicycles and packages in a common storage system. Storage system 800 includes item retrieval system 802. Item retrieval system 802 can selectively store, sort, and retrieve containerized bicycles 102 (in containers 120) and packages 804 stored on pallets 806 from any of the storage positions in storage system 800. In FIG. 8, one of container 120 has been moved to platform 708a and one of pallets 806 has been moved to platform 708b.

### Interface Between Vehicle Storage and Package Storage

There are several ways in which a storage system can be implemented to transfer packages (for example, in bags or bins, or on store either bikes or packages). In one example of this interface, the freight storage customer loads their packages into the storage system via the same space, and opening, used for bike storage.

In another example, the freight storage user accesses an opening in the side or back of the storage system, designed specifically for fright packages, and accessible only to freight customers. This version of the design may be partly or fully automated, either by a loading device built into the delivery vehicle (e.g., extending from the back or side of the delivery vehicle), or a loading device attached to the storage system, and extending out to the delivery vehicle.

In still another example, the storage system has an opening on the top of its structure, which slides aside to all the delivery vehicles to quickly deposit pallets or packages into one or more pre-reserved storage spaces in the storage system. This process could be fully or partly automated, or manually operated.

### Cargo Bike Storage and Delivery Wagon Storage Systems

Cargo bikes and delivery wagons are typically larger than conventional bikes and e-bikes—often much larger—because they also contain cargo or extra seating areas, and/or areas for packages and materials to be delivered. Also, some bikes have cargo spaces in the front of the bike, and others in the back. Further, because of their size, cargo bikes are not as easy to pick up or move into a “parking” position, such as would be typical for moving a bike into a storage rack. Thus, different designs may be employed for cargo bikes. This disclosure describes systems for space-efficient storage containers for these types of vehicles, as follows:
(1) For cargo bikes in general, the storage system can be one in which each bike can be wheeled directly from the curbside parking area into its storage area, which is a pallet (or, quite likely, a combination of two pallets) approximately 96″ long and 40″ wide. These dimensions accommodate the vast majority of cargo bikes, in a form factor that allows for easy adaptation to storage of large pallets (48″ by 48″, if need be).
(2) While some cargo bikes have low form factors, others have what amount to windshields or enclosures to protect drivers and passengers from rain, some cargo bike storage systems will be of different heights than the basic storage system design disclosed above: some will be up to 5′ or even 6′ high. Again, this larger size may actually work well with certain types of freight micro-logistics devices, some of which are 5′ or even 6′ tall. In these instances, the basic storage system can accommodate the same types of payloads, within a much taller enclosure.

### Folding Bike Storage

(1) Folding bikes may present the opposite issue to cargo bikes—most of them fold to a size so small that they are very easily stored, yet they weigh the same as (or more) than a conventional bike. For this reason, folding bikes will be accommodated primarily in the standard sized storage system, though perhaps with latches or bars sized specifically for those bikes (and their number limited).
(2) Alternately, folding bikes and scooters (including folding scooters, which have a very similar length and weight) may be stored in their own, specifically sized storage systems, in which the pallet sizes are designed to accommodate those vehicles. These specific storage systems for smaller or folding vehicles may include the hydrant design described below.

### Battery Charging and Modular Units; Add-on Storage and Ancillary Services

Although some of the storage systems described above are modular and sized for a particular street setting, storage systems can also be built that are deeper than 8′, wider than 30′, or both. Also, as noted above, multi-level storage systems can be implemented in train station parking lots and other areas that have height differentials, allowing for storage of vehicles below the level at which customers access the storage system. As described below, the storage systems can also be designed to allow for a wide range of “add-on” services and devices.

Each storage system may have a battery underneath its storage container area, providing basic power to the device itself, as well as charging services to charge e-bikes overnight.

A storage system may also have a direct connection to the power grid, and use that connection to offer battery charging for e-bikes, EV cars and trucks, or both. The car EV charging cables and other equipment may be attached to the outside of the storage system, or installed in one or more spaces within the storage system's rectangular shape, which would otherwise be used for vehicle storage.

Either along one edge of the storage system, or on top, or (if desired) within one space of the storage system's rectangular shape, may be located a battery-swapping facility, or other “service station” services, such as a tire pump, or repair equipment, for sale or rent.

Along the portions of the storage system that face the sidewalk, but are not used as doors to access storage, may be installed benches, seats, or a water fountain or other amenity. Similarly, steps may be installed (and an ADA lift), allowing pedestrians to access the top of the storage system, which could be fitted with seating, or a “beach” area, earning additional revenue and allowing for a variety of recreational use (and a barrier around its edge, to prevent people from falling into the street.

Solar panels may be installed either on the top of the storage system itself, or as part of an awning or cover above any seating area on the top of the storage system, and integrated into the storage system's charging system.

### Fireproofing Systems

One way that a storage system can reduce the risk of battery fires is by either using only verified bikes (either from bike-share programs, or private bikes registered with the storage system's operator). Alternately, the storage system may require that owners remove their batteries when storing their bikes- and offer them charging when they do so. This would reduce the possibility of a battery fire inside the storage system itself.

In some implementations, the motors' ability to offer synchronized movement of pallets in the storage system, and the installation of temperature sensors inside the storage system, allow the system to quickly detect any fire, and respond with a protocol that moves the pallet containing the fire to a specific area of the storage system that has an active fire suppression system (such as a foaming device).

### Fire Hydrant-Compatible Systems

In some implementations, a storage system uses space near a fire hydrant. In some implementations, the storage system is at least a minimum spacing from the fire hydrant.

In one example, a storage system is sized for cargo bikes, of the kind described above, installed at the edge of the 15′ perimeter of the hydrant, so that the cargo bike users can always access the storage system from the parking lane (except when there is a fire, of course)—and the freight delivery services can do the same, thus avoiding double-parking in the street or taking up legal parking spaces, and expediting the freight loading and unloading process.

In another implementation, a smaller storage system sized for folding bikes and scooters, with battery swapping and charging, installed just beyond at the edge of hydrant's 15′ zone. This storage system can be integrated into an outdoor seating area (at grade) that is itself designed around a semi-circle of folding benches that are outside of the 15′ zone.

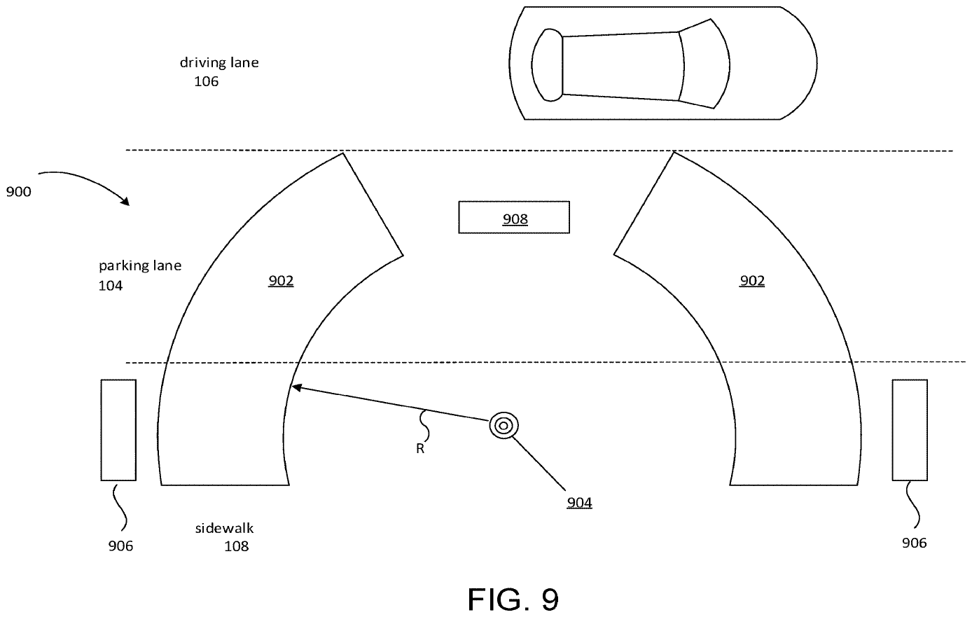

FIG. 9 illustrates one example of a storage system that has a minimum spacing from a fire hydrant. System 900 includes storage systems 902. Storage systems 902 have an arcuate shape. The sides of storage systems 902 are spaced away from fire hydrant 904 by a minimum of radius R. In one implementation, radius R is 15 feet. System 900 includes sidewalk benches 906 and parking lane bench 908. Parking lane bench 908 can be removable by fire-fighting personnel (e.g., with a special tool) to provide easy access between driving lane 106 and fire hydrant 904.

In some implementations, a storage system includes a central portion with a sleeve that is attached to the fire hydrant itself. The sleeve can be used to extend the hydrant's standpipe connection to the street lane itself. The system can also incorporate an actively monitoring mechanism, able to test the hydrant itself (for example, to avoid a “dud” hydrant).

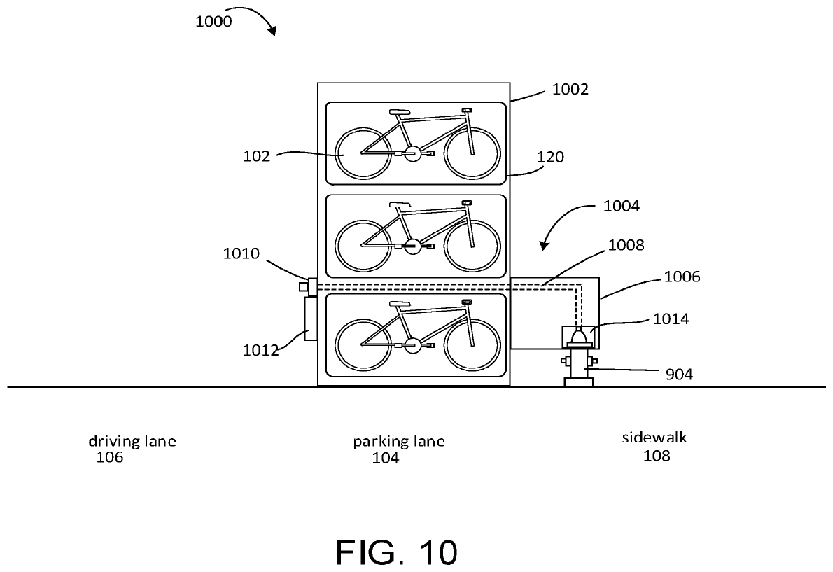

FIG. 10 illustrates one example of a storage system that provides an extension to a fire hydrant. System 1000 includes storage system 1002 and fire hydrant extension system 1004. Storage system 1002 can be used to store and retrieve bicycles 102 in container 120. In this example, storage system 1002 has three levels.

Fire hydrant extension system 1004 is built-in to storage system 1002. Fire hydrant extension system 1004 includes adapter 1006, piping 1008, street-side fitting 1010, and hydrant test system 1012. Adapter 1006 includes sleeve 1014. Sleeve can be placed on fire hydrant 904 such that fire hydrant 904 is fluidly coupled to street-side fitting 1010 via piping 1008. Fire-fighting personnel can access water from fire hydrant 904 by connecting to street-side fitting 1010. Hydrant test system 1012 can be used to test fire hydrant 904.

A retrieval system can include tracks or rails for motors to move on from storage position to storage position. Tracks can be include for left-to-right movement, forward-and-back movement, up-and-down movement, or combinations thereof. In some implementations, one motor system can move items in more than direction. In certain implementations, a retrieval system provides a mechanism for non-linear movement of container. Tracks or rails can be linear or any other suitable shape.

In one implementation, each of the front/back motors on each side of the storage system has a set of motors able to move left and right, effectively forming a grid of left-right motors that covers the entire interior. The motor control software can ensure that there are never two grabber arms or hooks in the same space at the same time.

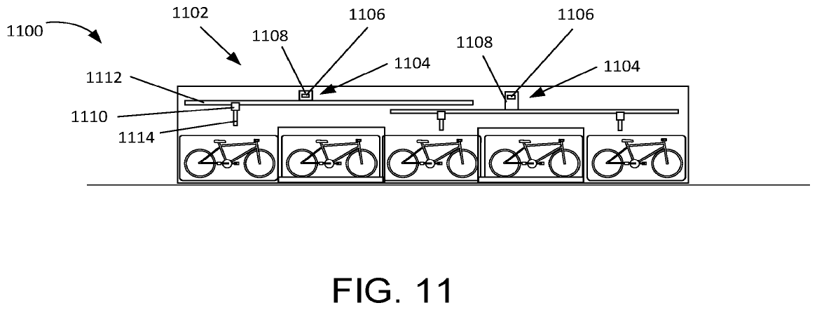

FIG. 11 is a front view of a storage system illustrating an alternate implementation that includes motor assemblies that move items left-to-right and front-to-back. Storage system 1100 includes retrieval system 1102. Retrieval system 1102 includes carriage units 1104 that travel on front back tracks 1106 by way of front-back motors 1108. Carriage units 1104 carry left-right motors 1110 on left-right tracks 1112. Grabber arms 1114 (or, alternatively, hooks) are coupled to left-right motors 1110 to couple with the containers or other items in storage system 1100.

Movement of multiple items within the storage space can be synchronous or asynchronous. Thus, for example, one or more motors can be operated to move all of the items in a particular row, or only one of several items in that row.

In various examples described and shown herein, a container for personal transportation devices includes two housing portions that cooperate with one another in a clamshell relationship. Other types of containers can be used, however. A container for stored multiple personal transportation devices can include a unitary housing, or it can include more than two housing portions.

In various examples described and shown herein, a system for storing and retrieving personal transportation devices enclosing an array of items on a single level. A storage system can however, have any number of levels. In some implementations, a controller operates to coordinate movement among and between two or more levels. Such systems can include motors that move items up or down a level in response to storage or retrieval needs.

In some examples described and shown herein, different portions of a container housing are connected to another by a hinge along a short side of the container. Other types of connections can be used, however. In some implementations, different portions of a container slide with respect to one another (rather than, pivot, for example), or are commonly connected to another element, such as a rod, a link, or a chain. In some implementations, portions of a container are connected along a top edge or a bottom edge. In some implementations, a container does not have a bottom.

Motorized storage and retrieval systems for personal transportation devices, as well as other automated features of the systems described herein, can be implemented in electronic circuitry, computer hardware, firmware, software, or in combinations thereof. Devices can include input and output devices, a computer processor, and a computer program product embodied in a machine-readable storage device for execution by a programmable processor. A controller can, among other things, monitor parameters of the system and send signals to actuate and/or adjust various operating parameters of the system. The controller, in certain instances, includes a processor and a memory containing instructions that cause the processors to perform operations described herein. The processors are coupled to an input/output (I/O) interface for sending and receiving communications with components in the system, including, for example, the electric motors, such as linear synchronous motors. While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. A portable storage container for personal transportation devices, comprising:
two or more housing portions; and
two or more personal transportation device mounting portions coupled to at least one of the housing portions and each configured to receive a personal transportation device.

2. The portable storage container of claim 1, wherein the two or more housing portions comprises a left housing portion and a right housing portion.

3. The portable storage container of claim 1, wherein:
the two or more housing portions comprises a left housing portion and a right housing portion, and
the left housing portion and right housing portion are configured to couple with one another to form a clam-shell enclosure.

4. The portable storage container of claim 1, wherein the two or more housing portions are configured to couple with one another to form a fireproof enclosure.

5. The portable storage container of claim 1, wherein the portable storage container is configured to hold a personal transportation device on each of at least two of the two or more housing portions.

6. (canceled)

7. The portable storage container of claim 1, further comprising a mid-panel, wherein at least one of the one or more personal transportation device mounting portions is coupled to the mid-panel.

8. The portable storage container of claim 1, wherein at least one of the personal transportation devices comprises at least one of a bicycle, an e-bike, or a cargo bike.

9. (canceled)

10. (canceled)

11. The portable storage container of claim 1, further comprising a charging port for a chargeable electrical device of the personal transportation device.

12. The portable storage container of claim 1, further comprising at least one of a fire detection device or a fire suppression device.

13. (canceled)

14. A portable storage container for personal transportation devices, The portable storage container of claim 1, further comprising:
one or more guides configured to guide at least one personal transportation device mounted in container into a complementary relationship with at least one other personal transportation device in the container.

15. The portable storage container of claim 14, wherein at least one of the guides comprises a receiving portion configured to receive a portion of the personal transportation device.

16. The portable storage container of claim 14, wherein at least one of the guides comprises user directions.

17. (canceled)

18. The portable storage container of claim 1, wherein the portable storage container comprises a center partition, wherein a mounting portion of the center partition comprises one or more guides configured to guide a personal transportation device coupled to the middle partition into a complementary arrangement with at least one personal transportation device mounted in an opposing housing portion.

19. A storage system for personal transportation devices, comprising:
two or more personal transportation device mounting portions each configured to receive a personal transportation device; and
one or more guides configured to guide at least one personal transportation device into a complementary arrangement with at least one other personal transportation device.

20. The storage system of claim 19, wherein the storage system comprises one or more housing portions configured to enclose the personal storage devices.

21. The storage system of claim 19, wherein the storage system comprises one or more pallets.

22. The storage system of claim 19, wherein the storage system comprises two or more bars, wherein each of at least one of the mounting portions is coupled to one or more of the bars.

23. The storage system of claim 19, wherein at least two adjacent personal transportation devices are in an alternating relationship to one another.

24. The storage system of claim 19, wherein at least two adjacent personal transportation devices are in an inverted relationship to one another.

25. The storage system of claim 19, wherein at least two adjacent personal transportation devices are in a syndiotactic relationship to one another.

26.-67. (canceled)
